(19) United States
(12) Patent Application Publication
(10) Pub. No.: US 2026/0295786 A1
(43) Pub. Date: Oct. 1, 2026

(54) METHOD FOR OPERATING AN ELECTRIC MACHINE TOOL, COMPUTER PROGRAM AND ELECTRIC MACHINE TOOL

(71) Applicant: Metabowerke GmbH, Nuertingen (DE)

(72) Inventor: Matthias Mueller, Kaelberbronn (DE)

(21) Appl. No.: 19/629,908

(22) Filed: Mar. 26, 2026

(30) Foreign Application Priority Data
Mar. 28, 2025 (DE) 10 2025 112 195.8

(51) Int. Cl. B25B 23/147; B25B 21/02

(52) U.S. Cl. CPC B25B 23/1475; B25B 21/02

(57) ABSTRACT

The invention relates to a method for operating an electric machine tool (1), in particular a torque wrench, having at least the following method steps:
operating an electric motor (4) of the electric machine tool (1) to drive a machining tool (9) to carry out a rotational machining procedure, in particular to tighten or loosen a screw connection;
monitoring a torque actual value (M_{ACT}) related to the machining procedure for at least some of the time during the machining procedure;
monitoring a rotation angle actual value (α_{ACT}) related to the machining procedure for at least some of the time during the machining procedure using a position sensor (13) of the electric motor (4);
ending the machining procedure after a torque setpoint value (M_{SET}) and a rotation angle setpoint value (α_{SET}) have been reached.

The present application for Patent claims priority to German Patent Application No. 10 2025 112 195.8 entitled “Method for operating an electric machine tool, computer program and electric machine tool” filed Mar. 28, 2025 and assigned to assignee hereof and hereby expressly incorporated by reference herein.

The invention relates to a method for operating an electric machine tool, in particular a torque wrench, according to which an electric motor of the electric machine tool is operated to drive a machining tool to carry out a rotational machining procedure, in particular to tighten or loosen a screw connection.

The invention further relates to a computer program.

The invention furthermore relates to an electric machine tool, in particular to a torque wrench, having a control device, an electric motor and a drive train mechanically connected to the electric motor, wherein the electric motor is able to be connected to a machining tool via the drive train to carry out a rotational machining procedure, in particular to tighten or loosen a screw connection, and wherein the control device is designed to operate the electric motor to carry out the machining procedure.

To screw in a screw, electric machine tools such as a drill driver or a cordless screwdriver are generally employed. However, conventional drill drivers offer the operator only limited possibilities to control the screwing procedure precisely. For example, in special applications, for a secure screw-fastening it is sometimes necessary to ensure the concrete torque of a screwing procedure, for example in the securing of wind turbine blades.

To improve control in a screwing procedure, electric screwdrivers are known which have torque limiting or torque regulation, in order to make the screwing-in of a screw into a workpiece more controllable. However, the torque actually applied depends on numerous factors, including the material of the workpiece, the type of screw and the screwdriver used. This can result in undesired deviations even in torque-regulated systems.

A drywall screwdriver is known from DE 10 2021 121 777 A1, the electric motor of which is driven by means of several individual pulses in order to make it possible for an operator to exert a pulse-width influence on the insertion of the screw. In this case it is envisioned that the screw is moved further by a predetermined rotation angle with each of the individual pulses. This rotation-angle-based operation indeed leads to a further improvement in the screwing procedure, but is not equally advantageously suitable for all applications.

In view of the known prior art, the present invention is based on the object of providing a method for operating an electric machine tool, with which method particularly precise control over the machining procedure, in particular a screwing procedure, is made possible, preferably with minimal, or completely without, additional hardware outlay in the electric machine tool.

The present invention is also based on the object of providing an advantageous computer program in order to perform such a method.

Finally, it is also an object of the invention to provide an electric machine tool that makes it possible for an operator to have particularly precise control over the machining procedure, in particular screwing procedure, preferably with minimal, or completely without, additional hardware outlay in the electric machine tool.

The object is achieved for the method with the features presented in claim 1. The object is achieved by the features of claim 14 with regard to the computer program and by claim 15 with regard to the electric machine tool.

The dependent claims and the features described below relate to advantageous embodiments and variants of the invention.

The invention relates to a method for operating an electric machine tool.

The electric machine tool is preferably an electric machine tool with rotational drive or an electric tool for torque transfer. Particularly advantageously, the method or the invention is suitable for electric screwdrivers (e.g. cordless screwdrivers), drill drivers, drywall screwdrivers, impact wrenches and torque wrenches. However, it should be emphasized that the method or the invention may be suitable in principle for use with any electric machine tools which are capable of producing a torque, therefore also for drills, impact drills, tap drills to grease guns or cartridge presses, for example. Even if concrete mention is sometimes made of “tightening or loosening of a screw connection” or of a “screwing procedure” below, this wording may be readily substituted or expanded by a person skilled in the art for any (rotary) machining procedure in which the controllability, according to the invention, of the rotational procedure may likewise be advantageous, as regards the above-mentioned examples inter alia.

According to the invention, it is envisioned to operate an electric motor of the electric machine tool to drive a machining tool to carry out a rotational machining procedure.

The rotational machining procedure is preferably, but not necessarily, a screwing procedure for tightening or loosening a screw connection, and the machining tool is consequently a screwdriver (e.g. a screw bit that is able to be brought into engagement with a screw head of a screw, or a socket wrench insert). It is generally envisioned to machine or to manipulate a workpiece and/or a separate tool with the machining tool.

The machining tool, that is e.g. the screwdriver, is preferably able to be connected to the electric machine tool detachably or interchangeably, for example to a tool holder of the electric machine tool (e.g. a drill chuck, a plug-in bit holder or a plug-in square drive, in particular for holding a socket wrench insert), which is driven directly via a drive train by a rotor of the electric motor or via a transmission.

At this point it should also emphasized that, in the context of the invention, the rotation direction around which the machining tool is rotated is not strictly important. The rotation direction may therefore take place clockwise or counter-clockwise, for example in order to optionally screw in or to loosen a screw or in order to actuate a left-hand thread. All of the procedures and method steps described above and below are therefore not to be understood as being limited to a concrete rotation direction.

According to the invention, it is envisioned to monitor a torque actual value related to the machining procedure for at least some of the time during the machining procedure. It is further envisioned furthermore to monitor a rotation angle actual value related to the machining procedure for at least some of the time during the machining procedure, wherein the rotation angle actual value may be recorded using a position sensor of the electric motor, as a result of which advantageously implementation of the invention preferably may take place without additional sensor technology (e.g. through purely software-related measures). The monitoring of the actual values mentioned may take place at the same time (at least partially or completely overlapping in time) or one after the other, wherein the torque actual value is preferably monitored first and the rotation angle actual value is monitored or taken into account only thereafter.

The rotation angle actual value is preferably recorded exclusively using at least one position sensor of the electric motor, which position sensor is already integrated in the electric motor. Therefore, a further position sensor is preferably not employed to record the rotation angle, in particular an additional position sensor is not employed. Thus, for example, a Hall sensor already installed in the electric motor may be sufficient to record the rotation angle.

According to the invention, it is envisioned to end the machining procedure after a torque setpoint value and a rotation angle setpoint value have been reached. This may take place immediately, after both setpoint values have been reached or also only after a defined delay.

As a criterion for ending the machining procedure, it may be envisioned in particular that the torque setpoint value is reached first and only subsequently is the rotation angle setpoint value reached.

The present invention makes more precise and more reliable control of the machining procedure possible, especially of a screwing procedure or rotational procedure, with respect to the prior art, as a result of which in particular an exact end position and a predefined tightening torque of a screw, screw nut or of another torque-based workpiece or tool can be ensured.

A crucial advantage arises here in the combination of torque control and rotation angle control. While conventional electric tools usually use either torque limiting or rotation-angle-based control, the present invention combines both aspects to control the rotational procedure. As a result, a higher level of process safety and controllability for the operator is achieved, in particular in applications in which the torque actually applied depends greatly on factors such as nature of material, screw type or friction conditions. According to the invention, this can be made possible by a small additional hardware outlay (preferably entirely without additional hardware outlay, which makes software-related retrofitting possible for existing electric machine tools), since recourse may be had to already existing sensor technology of the electric motor for recording the rotation angle.

In one advantageous development of the invention, it may be envisioned that the electric motor is operated in several operating phases.

In particular, it may be envisioned that the machining tool is operated in a first operating phase until the torque setpoint value is reached, and in a subsequent, second operating phase until the rotation angle setpoint value is reached.

In principle, the machining procedure can be continued further after the second operating phase, but is preferably ended immediately after the second operating phase.

The power or speed of the electric motor can be controlled or regulated optionally differently in each operating phase. The power or speed of the electric motor may in each case depend in particular on how far away the respective actual value still is from the setpoint value. For example, the speed can be lowered in steps or steplessly, if the actual value moves closer to the setpoint value (however, this is not strictly required).

According to a development of the invention, furthermore it may also be envisioned that the electric motor, after the second operating phase and before the ending of the machining procedure, is also operated in a third operating phase in which the machining tool is rotated back by a defined reverse rotation angle counter to the rotation direction used in the first two operating phases.

A reverse rotation may be advantageous in particular when the rotation angle setpoint value has been exceeded in the course of the preceding operating phase and is to be post-corrected. The reverse rotation can also be used to release any tension (torque stress), for example to reduce torsional forces in the thread.

According to a development of the invention, it may be envisioned that the torque actual value continues to be monitored in the second operating phase and/or in the third operating phase.

The further monitoring can take place, inter alia, in order to interrupt the machining procedure when a maximum torque in the second operating phase and/or in the third operating phase is exceeded. The maximum torque here may be in particular greater than or equal to the torque setpoint value.

In a development of the invention, it may be envisioned that the operation of the electric motor is interrupted or paused temporarily between the operating phases. The duration of the interruption can be adjusted optionally by an operator. The duration of the interruption can be selected to be long enough that the operator perceives the transition between the operating phases and/or such that the operator has sufficient reaction time to interrupt the machining procedure, in order to prevent entry into the following operating phase (e.g. by releasing an operating switch or by actuating a shut-off switch).

Additionally or alternatively, it may be envisioned that the transition between the operating phases is signaled optically (e.g. by an illuminant or an optical indicator or a display), acoustically (e.g. via a signal generator/buzzer or by targeted motor activation to produce acoustic feedback through the motor itself) and/or haptically (e.g. by vibration or stalling/stuttering of the drive).

In a development of the invention, it may be envisioned that the rotation angle setpoint value is defined as a relative rotation angle that is related to the rotation angle actual value at the time the torque setpoint value is reached, in order to rotate the machining tool further or back in a targeted manner proceeding from this.

In particular, the reverse rotation angle can likewise be a relative rotation angle, related to the time the rotation angle setpoint value is reached or to the actual state at the transition between the second operating phase and the third operating phase.

In principle, the further or relative rotation can take place around any rotation angle. However, the further rotation is preferably limited to fewer than ten revolutions, preferably fewer than five revolutions, further preferably to fewer than two revolutions, particularly preferably to less than one revolution or less than 360° or even less.

In an advantageous development of the invention, it may be envisioned that the machining procedure and/or individual operating phases is ended by a smooth switching-off of the electric motor.

For example, the power or speed of the electric motor can be reduced gradually (dropping linearly, dropping exponentially, dropping logarithmically, dropping in an s-shaped manner or dropping continuously in accordance with any curve). In principle, however, an abrupt or sudden switch-off may also be envisioned.

In a development of the invention, it may be envisioned that the ending of the machining procedure, that is a complete screwing-in procedure, for example, is signaled optically (e.g. by an illuminant or an optical indicator or a display), acoustically (e.g. via a signal generator/buzzer or by targeted motor activation to produce acoustic feedback through the motor itself) and/or haptically (e.g. by vibration or stalling/stuttering of the drive).

The notification of the end of the machining procedure improves the process safety and user friendliness, since the user clearly sees when the procedure is completed. As a result, operating errors and unnecessary repairs are reduced. Particularly in working environments in which a visual or tactile check of the result is not immediately possible, clear feedback ensures a more efficient and more precise way of working.

In an advantageous development of the invention, it may be envisioned that a user input is recorded via a user interface, in order to specify the torque setpoint value, the rotation angle setpoint value, a transmission ratio and/or a rotation direction of the machining tool.

In principle, the user interface can be any interface, wherein several user interfaces may also be envisioned. The user interface can have, inter alia, thumbwheels, input panels and output panels, buttons or a wire-free interface (e.g. Bluetooth interface). The concrete configuration of the user interface is not strictly important in the context of the invention.

The user interface can be integrated into the electric machine tool and/or a rechargeable battery pack of the electric machine tool. The user interface can also be realized as an application on a separate appliance that is connected to the electric machine tool in a cable-free or cabled manner, for example as an application on a smartphone, tablet computer or PC.

The possibility of specifying relevant parameters such as the torque setpoint value, the rotation angle setpoint value, the transmission ratio and/or the rotation direction of the machining tool via a user interface increases the flexibility and adaptability of the electric machine tool. The machining procedure can be adapted by the operator in a targeted manner to different workpiece materials, screw connections or machining requirements.

In an advantageous development of the invention, it may be envisioned that the torque actual value, the rotation angle actual value and/or the operating phase of the electric motor is output via an output interface of the electric machine tool during the operation of the electric machine tool.

As a result of the (continuous) provision of the information, the operator can record the present status of the machining procedure in real time and, where appropriate, undertake adaptations in order to ensure optimal machining quality.

By including the operator in the machining procedure, that is in particular by providing the information of the machining procedure and the possibility of the data input of the operator, the operator can input or optimize a reference machining procedure, for example, which can then serve as an aid for further machining procedures or for the partial or complete automation of later machining procedures (e.g. a corresponding algorithm can be trained on the basis of the feedback from the operator).

In an advantageous development of the invention, it may be envisioned that the machining procedure is documented in a control device, in particular machining parameters, quality data and process data and/or appliance information and user information.

The machining parameters to be documented may be screwing parameters, inter alia. Inter alia, the torque profile (e.g. actual torque vs. setpoint torque), the rotation angle profile (e.g. how far rotation was actually performed), the end values of torque and rotation angle reached, a time stamp of the machining procedure and/or the operating phases can be put together and documented.

The quality data and process data to be documented can be, inter alia, the result of the machining procedure (that is e.g. whether the setpoint values were reached and the machining was therefore successful or was not successful), remaining deviations from the setpoint values, the entire machining duration and/or recognized anomalies (such as e.g. an over-rotation, idle screwing, a recoil or the information that a predetermined torque or a predetermined rotation angle have not been reached).

The appliance information and user information can be, inter alia, a clear identifier of the electric machine tool or of the operator (in order to make tracking possible), a rechargeable battery level, the motor power, the temperature or other/further diagnostic data.

In a development of the invention, it may be envisioned that a Hall sensor, an optical encoder or a magnetic encoder is used as position sensor of the electric motor.

Hall sensors are employed regularly in electric motors of electric machine tools, since they offer a robust, compact and cost-efficient solution for position recording and are particularly suitable for adverse or dusty and dirty environmental conditions. The invention can therefore be implemented particularly advantageously by using the Hall sensors belonging to the motor.

It may be envisioned that the recording of the rotation angle actual value is additionally recorded using further parameters, such as e.g. motor parameters (e.g. motor voltage and motor current) and an operating temperature or the accuracy of the ascertained rotation angle are optimized by including the mentioned parameters for correction.

According to a development of the invention, it may be envisioned that the torque actual value is recorded via a torque sensor and/or calculated on the basis of a motor voltage, a motor current, a transmission ratio and/or an operating temperature.

The direct recording of the torque by means of a torque sensor generally makes particularly precise real-time measurement possible. Here, the sensor can be integrated in the tool holder or on a coupling at various locations, such as on the drive shaft.

In particular, if there is no torque sensor available or the employment thereof is too costly, alternatively (but also as a supplement to a torque sensor, where appropriate) the torque can be calculated indirectly from electrical and mechanical operating parameters. In general, the torque of an electric motor stands in direct relation to the motor power, and therefore a torque estimate is possible on the basis of motor voltage and motor current. In addition, the transmission ratio can be incorporated into the calculation, in particular if the electric machine tool has a multi-stage or adjustable transmission available to it. Furthermore, the operating temperature can be used as a correction parameter, in order to compensate for temperature-related influences on the system, such as resistance changes, and to increase the accuracy of the torque determination. Optionally, a calibration of the (sensorless) torque recording by using reference values (e.g. by user input via the user interface) may be envisioned.

At this point, it should be emphasized that the method steps described do not necessarily have to be carried out in the order in which they are first described or mentioned in the description or in the claims. For example, individual method steps or groups of method steps can therefore be interchangeable unless this is technically ruled out. Method steps may also be combined with one another, divided into separate intermediate steps or supplemented with intermediate steps. The method is also not necessarily conclusively described with the method steps described below and may be supplemented with further method steps, even ones not mentioned.

In the context of the invention, the electric machine tool or the electric motor can also be operated in a pulse mode, where appropriate. The desired setpoint values for torque or rotation angle can therefore also be reached by individual pulses. In principle, however, a permanent or consistent rotary movement is preferred.

The invention also relates to a computer program comprising control commands which, when the program is executed by a control device, cause this to carry out the method according to the embodiments above and below.

The control device can, preferably, be a control device of the electric machine tool.

The control device may be formed in particular as a microprocessor. Instead of a microprocessor, any further device for implementing the control device may also be envisioned, for example one or more arrangements of discrete electrical components on a printed circuit board, a programmable logic controller (PLC), an application-specific integrated circuit (ASIC) or another programmable circuit, for example also a field programmable gate array (FPGA) and/or a programmable logic arrangement (PLA).

The invention also relates to an electric machine tool, in particular to a torque wrench, having a control device, an electric motor and a drive train mechanically connected to the electric motor, wherein the electric motor is able to be connected to a machining tool via the drive train to carry out a rotational machining procedure, in particular to tighten or loosen a screw connection, and wherein the control device is designed to operate the electric motor to carry out the machining procedure, to monitor a torque actual value related in each case to the machining procedure and a rotation angle actual value for at least some of the time during the machining procedure and to end the machining procedure after a torque setpoint value and a rotation angle setpoint value have been reached. A position sensor of the electric motor is designed to record the rotation angle actual value and to transmit it to the control device.

In an advantageous manner, the invention makes more accurate, more flexible and more efficient control of a rotary machining procedure, such as e.g. a screwing procedure, possible. As a result of the combined use of torque control and rotation angle control and the universal employability in various electric tools due to the use of sensor technology belonging to the motor, process safety is increased, while the additional technical outlay remains minimal.

In the present case, the electric motor can be a brushless DC motor (BLDC), a universal motor or a synchronous motor, for example. In principle, the concrete design of the electric motor is not important in the context of the invention, insofar as the electric motor has a position sensor, such as a Hall sensor for example, which may be suitable for recording the rotation angle in the context of the invention.

The drive train may optionally have a transmission that can serve to adapt the speed and the torque. Depending on the embodiment, the transmission may be fixedly integrated into the electric machine tool or configured variably, in order to make application-dependent adaptation of the ratio possible.

The transmission may be realized, for example, by a mechanical manual transmission, a steplessly regulatable planetary transmission or an electronically controlled ratio regulation. A transmission adaptation or ratio adaptation may be advantageous, in particular, when different materials have to be machined or various types of screw have to be processed. In principle, a single-stage transmission may also be envisioned—the gear ratio may then be specified in production, for example.

The transmission may also be set up to be interchangeable, so that various transmission modules can be employed, depending on the application. This could take place by means of a plug system for change speed transmission or by means of an interchangeable gearhead, for example. As a result of this modularity, the electric machine tool can be adapted flexibly to various torque requirements and speed requirements, without a separate machine being required for each application. A transmission parameterization by user input at the user interface may also be envisioned.

Features which have been described in conjunction with one of the subjects of the invention, namely given by the method according to the invention, the computer program and the electric machine tool, are also advantageously able to be implemented for the other subjects of the invention. Likewise, advantages mentioned in connection with one of the subjects of the invention can also be understood in relation to the other subjects of the invention.

Supplementarily, it should be noted that terms such as “comprising”, “having” or “with” do not exclude other features or steps. Furthermore, terms such as “a/an” or “the” indicating steps or features in the singular do not exclude a plurality of features or steps—and vice versa.

In a puristic embodiment of the invention, it may however also be envisioned that the features introduced in the invention by the terms “comprising”, “having” or “with” are enumerated exhaustively. Accordingly, in the context of the invention, one or more enumerations of features can be considered to be self-contained, for example considered in each case for each claim. By way of example, the invention can consist exclusively of the features specified in claim 1.

It should be mentioned that labels such as “first” or “second”, etc. are used predominantly for the sake of distinguishability between respective device or method features, and are not necessarily intended to indicate that features are mutually dependent or related to one another.

Furthermore, it should be emphasized that the values and parameters described in the present case also encompass deviations or fluctuations of ±10% or less, preferably ±5% or less, more preferably ±1% or less, and very particularly preferably ±0.1% or less, of the respectively stated value or parameter, provided that these deviations are not excluded in practice when implementing the invention. The specification of ranges by way of start and end values also encompasses all values and fractions encompassed by the respectively stated range, in particular the start and end values and a respective mean value.

Exemplary embodiments of the invention will be described in more detail below with reference to the drawings.

The figures each show preferred exemplary embodiments in which individual features of the present invention are illustrated in combination with one another. Features of one exemplary embodiment are also able to be implemented separately from the other features of the same exemplary embodiment, and can accordingly be readily combined by a person skilled in the art to form further useful combinations and sub-combinations with features of other exemplary embodiments.

In the figures, functionally identical elements are provided with the same reference signs.

In the figures, in each case schematically:

FIG. 1 shows an electric machine tool according to the invention;

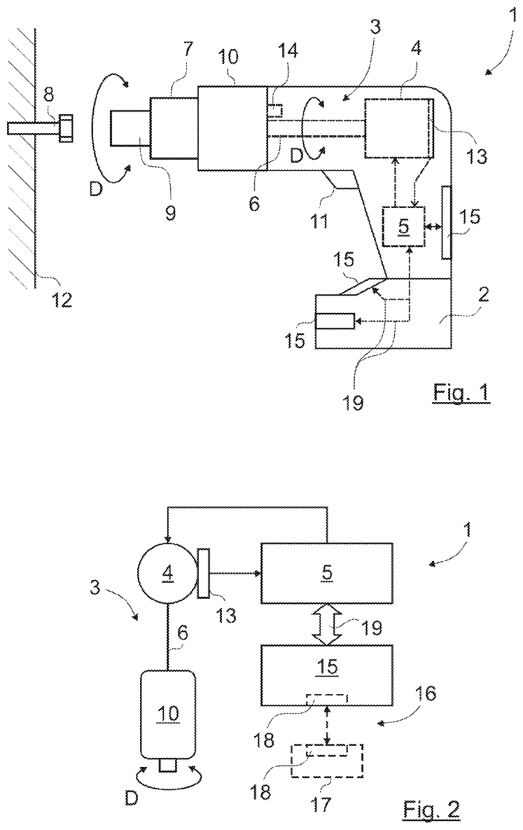

FIG. 2 shows a functional diagram of the electric machine tool;

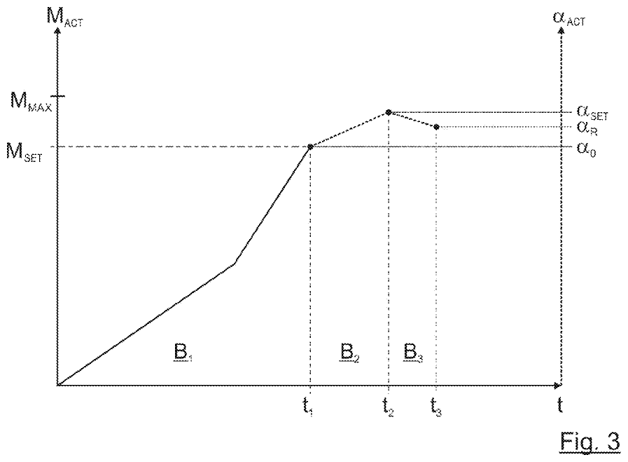

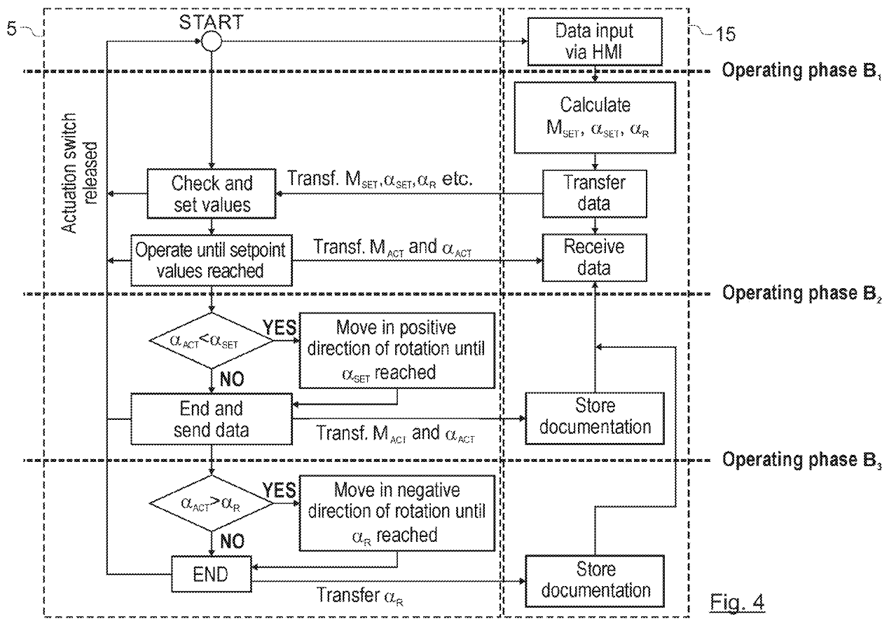

FIG. 3 shows a method sequence according to the invention with several operating phases of the electric machine tool; and

FIG. 4 Shows a Flowchart of the Method According to the invention.

FIG. 1 shows an electric machine tool 1 according to the invention according to an embodiment of the invention in a schematic depiction. A functional diagram of the invention or of the electric machine tool 1 is furthermore shown in FIG. 2. With reference to FIG. 4, individual exemplary method steps of the invention and the interplay between them, which will be discussed in more detail below, are additionally depicted schematically using a flowchart.

By way of example, an accumulator-operated electric machine tool 1 is depicted, which can have an interchangeable rechargeable battery pack 2. In principle, however, the invention is also suitable for use with cable-operated electric machine tools and, where appropriate, even for use with stationary electric machine tools. The electric machine tool 1 has an electric motor 4, connected to a drive train 3, and a control device 5. The electric motor 4 can have in particular a stator and a rotor. Via a drive shaft 6, the rotor of the electric motor 4 can be connected to a tool holder 7 in which a screwdriver 9 that is able to be brought into engagement with a screw 8 is fastened. Optionally, an adjustable or changeable transmission 10 may be envisioned.

At this point, it should be emphasized that instead of the screwdriver 9, in principle any machining tool may be envisioned. The invention is generally suitable for use with electric machine tools 1 which carry out any (rotary) machining procedure. The description below therefore only relates to a screwing procedure by way of example and in this regard should not be understood as being limiting.

The electric machine tool 1 can be actuated by an operator by means of an actuating switch 11, in order to screw the screw 8 (or a screw nut) into a workpiece 12, or to insert it into a workpiece 12, in as controlled a manner as possible. Screwing out or loosening the screws 8 may also be envisioned in the context of the invention. The algorithm or the proposed method can be completely parameterizable by the operator preferably in both rotation directions D—in the simplest case, the rotation direction D can be predetermined by the operator.

The control device 5 is designed and electrically connected to the electric motor 4 in order to drive the electric motor 4 to carry out the rotational machining procedure or screwing procedure. For this purpose, in particular a computer program can be executed on the control device 5, which computer program comprises suitable control commands to carry out the method, described above and below, correspondingly.

To record the rotary movement of the machining tool or screwdriver 9, measurement values of a position sensor 13 of the electric motor 4 are employed (e.g. of a Hall sensor). In this way, a rotation angle actual value α_{ACT} can be monitored at least for some of the time during the machining procedure (cf. FIG. 3 also described below).

In addition, in the context of the invention, a torque actual value M_{ACT} of the machining procedure is recorded at least for some of the time during the machining procedure (cf. FIG. 3 also described below). The torque actual value M_{ACT} can be recorded here via a torque sensor 14 (indicated optionally and as a dashed line in FIG. 1) and/or can be calculated on the basis of a motor voltage, a motor current, a transmission ratio and/or an operating temperature or other parameters using a model of the control device 5.

The control device 5, which preferably controls the entire electric machine tool 1, but at least the operation of the electric motor 4 on the basis of the torque actual value M_{ACT} and of the rotation angle actual value α_{ACT}, can record the data of various sensors, including those of the position sensor 13 already mentioned, in order to calculate the respective actual value.

As already mentioned, the electric machine tool 1 preferably can be equipped with various transmissions (transmission ratios), as a result of which the ratio of motor revolution to shaft revolution changes. This change in appliance behavior can be stored in the control device 5 or in a user interface 15 (HMI module), for example.

It may be envisioned to record and specify at least one torque setpoint value M_{SET}, at least one rotation angle setpoint value α_{SET}, the transmission ratio and/or the rotation direction D of the machining tool or screwdriver 9 by means of a user input via said user interface 15. The user interface 15 may be situated, inter alia, at one of the three positions depicted in FIG. 1, that is for example on the rechargeable battery pack 2, within the electric machine tool 1, on an outer side of the electric machine tool 1 (e.g. in the form of an optical display) or also in the form of a cable-free interface 16 (cf. FIG. 2), in order to make the user input for example by means of an application executed on a separate appliance 17 (e.g. a mobile terminal, such as a smartphone) possible. By way of example, a cable-free interface 16 is shown in FIG. 2, wherein the user interface 15 of the electric machine tool 1 and the external appliance 17 each can have a module 18 for wire-free or wired data transfer (e.g. a Bluetooth module). In particular, however, wired data transfer 19 between the user interface 15 and the control device 5 may be envisioned (shown partially as a dashed line in FIG. 1 and as a broad double arrow in FIG. 2).

As already mentioned, the proposed algorithm or the method primarily makes use of the position sensor technology, already installed in the drive train 3, of the electric motor 4, wherein further parameters such as diverse operating temperatures, operating voltages & operating currents can be incorporated into the algorithm, however, for example in order to further improve the accuracy of the recorded actual values for torque and rotation angle. Possible further input variables can be input by the operator through the user interface 15. The user interface 15 may optionally also take over the calculation of the transmission ratio, which can also be implemented in the control device 5 or in the main control electronics of the electric machine tool 1, however.

The operator is preferably able to predetermine a torque setpoint value M_{SET} and a rotation angle setpoint value α_{SET} independently of one another. The rotation angle accuracy can be defined by the transmission ratio and the position sensor 13 of the electric motor 4.

With reference to the diagram in FIG. 3, a possible screwing procedure in the context of the invention will now be explained by way of example. In the diagram, the torque actual value M_{ACT} (left-hand side, solid line) and the rotation angle actual value α_{ACT} (right-hand side, dashed line) are each plotted over the time t of the machining procedure. The depicted torque setpoint value M_{SET} and the rotation angle setpoint value α_{SET} can be predetermined by the operator via the user interface 15, as already mentioned.

In a first operating phase B₁ of the screwing procedure, the screw-fastening is tightened up to the switch-off torque predetermined by the operator or up to the torque setpoint value M_{SET}. For this purpose, the algorithm preferably does not make use of additional torque sensor technology (which is also possible, however), but rather works out the currently present torque or the torque actual value M_{ACT} from various operating parameters, such as the motor current, the motor voltage and a motor temperature/electronics temperature/battery temperature, for example, and possibly stored further parameters, such as transmission parameters and training parameters. After the torque setpoint value M_{SET} has been reached, the algorithm moves into a second operating phase B₂ at the time t₁.

It may be envisioned that the method is interrupted or paused temporarily at the transition into the next operating phase. A corresponding pause time (for example between the first operating phase B₁ and the second operating phase B₂) may be definable through the user interface 15. Alternatively or additionally, the transition between operating phases can be signaled optically, acoustically and/or haptically. An interruption or a signaling of a transition between operating phases is, however, not strictly required.

In the second operating phase B₂, the reference variable changes from the torque setpoint value M_{SET} to a rotation angle setpoint value α_{SET}, that is to say, the screw-fastening continues to be tightened up to a positive rotation angle setpoint value α_{SET} predetermined by the operator. Here, the rotation angle setpoint value α_{SET} is preferably defined as a relative rotation angle that is related to the rotation angle actual value α_{ACT} at the time the torque setpoint value M_{SET} is reached, in order to move the machining tool or screwdriver 9 further by a relative rotation angle of preferably 0° to 360° proceeding from here. The path-controlled activation in the second operating phase B₂ has the advantage, with respect to a time-controlled activation, that the electric motor 4 can be used to advance along a defined path and/or through a defined rotation angle irrespective of the load being applied. As already mentioned, the algorithm primarily makes use of the motor position sensor technology for this purpose, but can also incorporate present operating parameters where appropriate. Reaching of the position can be supported by a position regulator, which is implemented with the parameters already mentioned.

It may be envisioned that the torque setpoint value M_{SET} also continues to be monitored in the second operating phase, in order to ensure that an optionally predeterminable maximum torque M_{MAX} is not exceeded. Should the maximum torque M_{MAX} subsequently be exceeded, it may be envisioned to abort the second operating phase B₂.

It may be envisioned that the electric motor 4 is switched off immediately after the second operating phase B₂ or immediately after both setpoint values α_{SET}, M_{SET} have been reached (that is at the time t₂ in FIG. 3). For this, preferably (but not necessarily) a smooth switching-off or a gradual dropping of the speed may be envisioned. Supplementarily, the ending of the machining procedure may also be signaled optically, acoustically and/or haptically.

As an alternative to an immediate ending of the machining procedure or screwing procedure, however, a third operating phase B₃ inter alia may also be envisioned, in which the screw-fastening is advanced up to a negative or counter-directed reverse rotation angle α_{R} specified by the operator (the optional reverse rotation angle α_{R} may be definable by the operator via the user interface 15, for example, and/or be calculated on the basis of further parameters and/or standards). Alternatively, in the third operating phase B₃, advancement may also take place in the negative rotation direction D for a defined time, where appropriate. The third operating phase B₃, that is the movement of the screwdriver 9 counter to the previous rotation direction D, may in particular be useful in order to undo a recognized, undesired over-rotation of the screw 8 or in order to release an (excess) screw tension.

The proposed angle adjustment can be employed both in a positive and in a negative rotation direction D. The application area in the negative rotation direction D is advantageous, inter alia, for a defined release torque or a release rotation angle. This may serve, for example, to release in a defined manner the screwing-in tension of a nut to a screw head or to a screw nut. Moreover, the algorithm can likewise be employed for screw connections with a left-hand thread.

The described method makes the control of the tightening angle or rotation angle inter alia of screw-fastenings possible without additionally installed angle sensor technology or rotation sensor technology in the electric machine tool 1, since the sensor technology belonging to the motor can be used. The described algorithm, which ascertains the tightening angle or rotation angle for example with the Hall sensors or position sensors 13 situated in the electric motor 4, which sensors are required for the commutation, guarantees a highly precise and controllable screw-fastening.

It may be envisioned that the control device 5 or the main electronics of the electric machine tool 1 outputs both live data, such as e.g. the present torque, the present rotation angle as well as data after the adjusted parameters have been reached, via the user interface 15 or an additional output interface. Furthermore, a successful machining procedure or screwing procedure can be confirmed via the user interface 15 or output interface and optionally stored for documentation purposes.

1. Method for operating an electric machine tool (1), in particular a torque wrench, having at least the following method steps:
operating an electric motor (4) of the electric machine tool (1) to drive a machining tool (9) to carry out a rotational machining procedure, in particular to tighten or loosen a screw connection;
monitoring a torque actual value (M_{ACT}) related to the machining procedure for at least some of the time during the machining procedure;
monitoring a rotation angle actual value (α_{ACT}) related to the machining procedure for at least some of the time during the machining procedure using a position sensor (13) of the electric motor (4);
ending the machining procedure after a torque setpoint value (M_{SET}) and a rotation angle setpoint value (α_{SET}) have been reached.

2. Method according to claim 1,
characterized in that the electric motor (4) is operated in several operating phases (B₁, B₂, B₃), wherein the machining tool (9) is driven in a first operating phase (B₁) until the torque setpoint value (M_{SET}) is reached, and driven in a subsequent, second operating phase (B₂) until the rotation angle setpoint value (α_{SET}) is reached, wherein the machining procedure is ended after the second operating phase (B₂).

3. Method according to claim 2,
characterized in that the electric motor (4), after the second operating phase (B₂) and before the ending of the machining procedure, is operated in a third operating phase (B₃) in which the machining tool (9) is rotated back by a defined reverse rotation angle (α_{R}) counter to the rotation direction (D) used in the first two operating phases (B₁, B₂).

4. Method according to claim 2 or 3,
characterized in that the torque actual value (M_{ACT}) continues to be monitored in the second operating phase (B₂) and/or in the third operating phase (B₃), in order to interrupt the machining procedure when a maximum torque (M_{MAX}) is exceeded in the second operating phase (B₂) and/or in the third operating phase (B₃).

5. Method according to one of claims 2 to 4,
characterized in that the operation of the electric motor (4) is interrupted temporarily between the operating phases (B₁, B₂, B₃) and/or in that the transition between the operating phases (B₁, B₂, B₃) is signaled optically, acoustically and/or haptically.

6. Method according to one of claims 1 to 5,
characterized in that the rotation angle setpoint value (α_{SET}) is defined as a relative rotation angle that is related to the rotation angle actual value (α_{ACT}) at the time the torque setpoint value (M_{SET}) is reached, in order to rotate the machining tool (9) further or back in a targeted manner proceeding from this, preferably by a maximum of 360°.

7. Method according to one of claims 1 to 6,
characterized in that the machining procedure is ended by a smooth switching-off of the electric motor (4).

8. Method according to one of claims 1 to 7,
characterized in that the ending of the machining procedure is signaled optically, acoustically and/or haptically.

9. Method according to one of claims 1 to 8,
characterized in that a user input is recorded via a user interface (15), in order to specify the torque setpoint value (M_{SET}), the rotation angle setpoint value (α_{SET}), a transmission ratio and/or a rotation direction (D) of the machining tool (9).

10. Method according to one of claims 1 to 9,
characterized in that the torque actual value (M_{ACT}), the rotation angle actual value (α_{ACT}) and/or the operating phase (B₁, B₂, B₃) of the electric motor (4) is output via an output interface of the electric machine tool (1) during the operation of the electric machine tool (1).

11. Method according to one of claims 1 to 10,
characterized in that the machining procedure is documented in a control device (5), in particular machining parameters, quality data and process data and/or appliance information and user information.

12. Method according to one of claims 1 to 11,
characterized in that a Hall sensor, an optical encoder or a magnetic encoder is used as position sensor (13) of the electric motor (4).

13. Method according to one of claims 1 to 12,
characterized in that the torque actual value (M_{ACT}) is recorded via a torque sensor (14) and/or calculated on the basis of a motor voltage, a motor current, a transmission ratio and/or an operating temperature.

14. Computer program comprising control commands which, when the program is executed by a control device (5), cause this to carry out the method according to one of claims 1 to 13.

15. Electric machine tool (1), in particular torque wrench, having a control device (5), an electric motor (4) and a drive train (3) mechanically connected to the electric motor (4), wherein the electric motor (4) is able to be connected to a machining tool (9) via the drive train (3) to carry out a rotational machining procedure, in particular to tighten or loosen a screw connection, and wherein the control device (5) is designed to operate the electric motor (4) to carry out the machining procedure, to monitor a torque actual value (M_{ACT}) related in each case to the machining procedure and a rotation angle actual value (α_{ACT}) for at least some of the time during the machining procedure and to end the machining procedure after a torque setpoint value (M_{SET}) and a rotation angle setpoint value (α_{SET}) have been reached, and wherein a position sensor (13) of the electric motor (4) is designed to record the rotation angle actual value (α_{ACT}) and to transmit it to the control device (5).
